(19) United States
(12) Patent Application Publication
(10) Pub. No.: US 2017/0335047 A1
(43) Pub. Date: Nov. 23, 2017

(54) POLYURETHANE DISPERSIONS BASED ON RENEWABLE RAW MATERIALS

(71) Applicant: BASF SE, Ludwigshafen (DE)

(72) Inventors: Kathrin COHEN, Mannheim (DE); Karl HAEBERLE, Speyer (DE); Helfried SCHEIDL, Friedelsheim (DE); Henning WETTACH, Heidelberg (DE)

(73) Assignee: BASF SE, Ludwigshafen (DE)

(21) Appl. No.: 15/523,860

(22) PCT Filed: Oct. 30, 2015
(86) PCT No.: PCT/EP2015/075350

§ 371 Date: May 2, 2017

(30) Foreign Application Priority Data
Nov. 3, 2014 (EP) 14191496.0

(51) Int. Cl. C08G 18/42; C09D 175/06; C08G 18/32; C08J 3/05; C08G 18/24; C08G 18/72; C09J 175/06; C08G 18/75

(52) U.S. Cl. CPC C08G 18/4241; C09J 175/06; C09D 175/06; C08G 18/758; C08J 3/05; C08G 18/246; C08G 18/755; C08G 18/722; C08G 18/325; C08G 18/3206; C08J 2375/06

(57) ABSTRACT

A polyurethane dispersion PUD comprises at least one polyurethane P based on at least one polyisocyanate and at least one polyester polyol PES, wherein the polyester polyol PES is based on at least one polyhydric alcohol A and at least one dicarboxylic acid D, wherein at least one polyhydric alcohol A and/or at least one dicarboxylic acid D were at least partly derived from renewable raw materials.

The present invention relates to polyurethane dispersions PUD comprising at least one polyurethane P based on at least one polyisocyanate and at least one polyester polyol PES, wherein the polyester polyol PES is based on at least one polyhydric alcohol A and at least one dicarboxylic acid D, wherein at least one polyhydric alcohol A and/or at least one dicarboxylic acid D were at least partly derived from renewable raw materials. The present invention further relates to processes for producing polyurethane dispersions PUD and their method of use.

Polymeric hydroxy compounds such as polyester polyols react with isocyanates to form polyurethanes which have various possible uses, depending on their specific mechanical properties. Polyester polyols in particular have favorable properties and so are used for high-grade polyurethane products.

Polyurethanes at least partly obtained by use of renewable raw materials are known, for example from WO 2011/083000 A1, WO 2012/173911 A1 or WO 2010/031792 A1.

The use of natural raw materials in the polymer industry is becoming more and more significant because the starting materials are occasionally less costly. There is also increasing market demand for polyurethane products based on renewable raw materials and hence at least partial replacement of petrochemical raw materials.

Natural raw materials are more particularly substances obtained by processing plants or parts of plants (or else animals). Raw materials from renewable sources are characterized by a significant proportion of the carbon isotope ¹⁴C. Its determination allows experimental determination of the proportion of renewable raw materials. Renewable raw materials differ from materials obtained by chemical synthesis and/or by petroleum processing in that they are less homogeneous—their composition can vary to a distinctly greater extent.

Fluctuations in the composition of natural raw materials are for example dependent on factors such as the climate and region in which the plant grows, the time of year at which it is harvested, variations between biological species and subspecies and the type of extraction method used to recover the natural raw material (extrusion, centrifugation, filtering, distillation, cutting, pressing, etc.). These fluctuations in the composition of natural raw materials and the presence of further, difficult-to-remove concomitants, such as degradation products or impurities, frequently lead to problems in further processing and therefore limit the industrial uses of these materials.

The production of polyurethane dispersions from renewable raw materials is of considerable interest for ecological reasons.

It is an object of the present invention to use renewable raw materials to provide polyurethane dispersions whose performance characteristics are at least equivalent to those of polyurethane dispersions based on petrochemical raw materials.

We have found that this object is achieved according to the invention by polyurethane dispersions PUD comprising at least one polyurethane P based on at least one polyisocyanate and at least one polyester polyol PES, wherein the polyester polyol PES is based on at least one polyhydric alcohol A and at least one dicarboxylic acid D, wherein at least one polyhydric alcohol A and/or at least one dicarboxylic acid D were at least partly derived from renewable raw materials.

Here the expression “wherein at least one polyhydric alcohol A and/or at least one dicarboxylic acid D was at least partly derived from renewable raw materials” is to be understood as meaning that either at least one polyhydric alcohol A or at least one dicarboxylic acid D or at least one polyhydric alcohol A and at least one dicarboxylic acid D were at least partly derived from renewable raw materials. Where polyesterol PES is based on more than one polyhydric alcohol A and/or more than one dicarboxylic acid D, at least one of the polyhydric alcohols A and/or at least one of the dicarboxylic acids D shall have been at least partly derived from renewable raw materials. It is thus possible, for example, that polyesterol PES is based on a polyhydric alcohol A at least partly derived from renewable raw materials and also on a different, fully petrochemically produced polyhydric alcohol A. It is similarly possible, for example, that polyesterol PES is based on a dicarboxylic acid D at least partly derived from renewable raw materials and also on a different, fully petrochemically produced dicarboxylic acid D.

The expression “based on” herein is to be understood as meaning “produced from”, while the list of the components recited thereafter is not exhaustive.

Polyurethane dispersions PUD of the present invention as a rule are aqueous.

Polyurethane dispersions PUD comprise at least one polyurethane P. As a rule, polyurethane dispersions PUD comprise from 10 to 75 wt % of polyurethane, based on the dispersion. In a preferred embodiment, polyurethane dispersions PUD comprise polyurethanes P obtained by the prepolymer mixing process, especially those obtained by the hereinbelow described process for producing polyurethane dispersions PUD in the manner of the present invention.

Aqueous polyurethane dispersions PUD as a rule comprise from 90 to 25 wt % of water, based on the dispersion.

The polyurethanes P are prepared using at least one polyester polyol PES, wherein the polyester polyol PES is based on at least one polyhydric alcohol A and at least one dicarboxylic acid D, wherein at least one polyhydric alcohol A and/or at least one dicarboxylic acid D were at least partly derived from renewable raw materials.

Verification that a feedstock was derived from renewable raw materials is possible according to ASTM D6866 via 14C for example. A feedstock shall be regarded as “derived from renewable raw materials” for the purposes of this invention when the carbon-14 (C-14) presence therein corresponds substantially (to within not more than 6%) to the ASTM D6866 content of C-14 in atmospheric CO2.

The C-14 content of a material may be determined by determining the decays of C-14 in this material by liquid scintillation. Such raw materials shall preferably be regarded as derived from renewable raw materials when they have a C-14 content displaying a radioactive decay of not less than 1.5 dpm/gC (decays per minute per gram of carbon), preferably 2 dpm/gC, more preferably 2.5 dpm/gC and yet more preferably 5 dpm/gC.

The polyester polyols PES employed for the purposes of the present invention preferably have an average functionality in the range from 1.8 to 2.3, more preferably in the range from 1.9 to 2.2 and specifically of 2. The polyester polyol PES is preferably a polyester diol. Accordingly, in a further embodiment, the present invention provides polyurethane dispersions PUD comprising a polyurethane P based on at least one polyisocyanate and at least one polyester diol, wherein the polyester diol is based on at least one polyhydric alcohol A and at least one dicarboxylic acid D, wherein at least one polyhydric alcohol A and/or at least one dicarboxylic acid D were at least partly derived from renewable raw materials.

Suitable molecular weight ranges for the polyester polyols PES employed for the purposes of the present invention are known per se to a person skilled in the art. In one preferred embodiment, the molecular weight of the polyester polyol PES is in the range from 500 to 4000 g/mol, more preferably in the range of 800 and 3000 g/mol and most preferably in the range of 1000 and 2500 g/mol.

Particularly suitable polyester polyols PES for the purposes of the present invention have an OH number in the range from 25 to 230 mg KOH/g, more preferably in the range from 35 to 140 mg KOH/g and most preferably in the range from 40 to 115 mg KOH/g (KOH number determined as per DIN 53240).

In the present invention, the polyester polyol PES is based on at least one polyhydric alcohol A. Suitable polyhydric alcohols A include, for example, polyhydric aliphatic alcohols, for example aliphatic alcohols having 2, 3, 4 or more OH groups, for example 2 or 3 OH groups. Suitable aliphatic alcohols for the purposes of the present invention include, for example, C2 to C12 alcohols, preferably C2 to C8 alcohols and most preferably C2 to C6 alcohols. It is preferable for the purposes of the present invention for the at least one polyhydric alcohol A to be a diol, in which case suitable diols are known per se to a person skilled in the art.

Suitable aliphatic C2 to C6 diols include, for example, ethylene glycol, diethylene glycol, 3-oxapentane-1,5-diol, 1,3-propanediol, 1,2-propanediol, dipropylene glycol, 1,4-butanediol, 1,5-pentanediol, 1,6-hexanediol, 2-methyl-1,3-propanediol and 3-methyl-1,5-pentanediol. It is further preferable for the at least one polyhydric alcohol A to be selected from the group consisting of 1,3-propanediol and 1,4-butanediol.

In a further embodiment, the present invention also provides polyurethane dispersions PUD comprising at least one polyurethane P, wherein the at least one polyhydric alcohol A is selected from the group consisting of aliphatic C2 to C6 diols.

In a further embodiment, the present invention also provides polyurethane dispersions PUD comprising at least one polyurethane P, wherein the at least one polyhydric alcohol A is selected from the group consisting of 1,3-propanediol and 1,4-butanediol.

In one embodiment, polyesterols PES are based on at least one polyhydric alcohol A wherein at least one alcohol A was at least partly derived from renewable raw materials. The polyhydric alcohol A in question may be partly or wholly derived from renewable raw materials. It is also possible to employ a mixture of two or more polyhydric alcohols A in the present invention. Where a mixture of two or more polyhydric alcohols A is employed, one or more of the polyhydric alcohols A used may be at least partly derived from renewable raw materials. Suitable alcohols A which are at least partly derivable from renewable raw materials include, for example, 1,3-propanediol, 1,4-butanediol, ethylene glycol, isosorbide, furandimethanol and tetrahydrofurandimethanol.

1,3-Propanediol may accordingly be synthetically produced 1,3-propanediol, but in particular 1,3-propanediol from renewable raw materials (“biobased 1,3-propanediol”). Biobased 1,3-propanediol is derivable from maize (corn) and/or sugar for example. A further possibility is the conversion of waste glycerol from biodiesel production. In a further preferred embodiment of the invention, the at least one polyhydric alcohol A is 1,3-propanediol at least partly derived from renewable raw materials.

In a further embodiment, the present invention also provides polyurethane dispersions PUD comprising at least one polyurethane P, wherein the at least one polyhydric alcohol A is 1,3-propanediol at least partly derived from renewable raw materials.

Alcohols A having three or more OH groups are also employable as synthon components to increase the functionality of the polyester polyols PES. Examples thereof are glycerol, trimethylolpropane and pentaerythritol. It is also possible to employ oligomeric or polymeric products having two or more hydroxyl groups. Examples thereof are polytetrahydrofuran, polylactones, polyglycerol, polyetherols, polyesterol or α,ω-dihydroxypolybutadiene.

In one embodiment, polyester polyol PES is based not only on at least one polyhydric alcohol A but also on at least one dicarboxylic acid D, wherein at least one dicarboxylic acid D was at least partly derived from renewable raw materials. Suitable dicarboxylic acids D for preparing polyester polyols are known per se to a person skilled in the art.

One embodiment utilizes a mixture of two or more dicarboxylic acids D, for example a mixture of two, three or 4 dicarboxylic acids D. A mixture of two or three different dicarboxylic acids D selected from the group of C2 to C12 dicarboxylic acids may be concerned in the context of the present invention for example. By C2 to C12 dicarboxylic acids are meant dicarboxylic acids which are aliphatic or branched and have from two to twelve carbon atoms. It is also possible for dicarboxylic acids D employed for the purposes of the present invention to be selected from C2 to C14 dicarboxylic acids, preferably C4 to C12 dicarboxylic acids and more preferably C6 to C10 dicarboxylic acids.

In one embodiment, one or more of the dicarboxylic acids D used may also be in the form of a carboxylic diester or in the form of a carboxylic anhydride. Aliphatic and/or aromatic dicarboxylic acids may in principle be employed as dicarboxylic acid D.

One embodiment utilizes a mixture of two or more dicarboxylic acids D wherein at least one of the at least two dicarboxylic acids D was at least partly derived from renewable raw materials. The mixture employed therein in the context of the present invention may also comprise three or more dicarboxylic acids D, wherein at least one of the comprised dicarboxylic acids D was at least partly derived from renewable raw materials. In one embodiment of the present invention, the mixture used consists of two dicarboxylic acids D, wherein at least one of the two dicarboxylic acids D was at least partly derived from renewable raw materials.

Suitable dicarboxylic acids D are derivable from natural raw materials by specific methods of processing. For instance, treating castor oil with sodium hydroxide or potassium hydroxide at high temperatures in the presence of comparatively long-chain alcohols (such as 1- or 2-octanol) will result in sebacic acid being obtainable in a purity of >99.5% among other products depending on the reaction conditions. Sebacic acid (1,8-octanedicarboxylic acid) is a member of the homologous series of aliphatic dicarboxylic acids. Succinic acid and/or 2-methylsuccinic acid are particularly suitable for the purposes of the present invention as well as sebacic acid. They are derivable for example from natural raw materials such as sugar or maize (corn) by fermentation. Azelaic acid at least partly derived from renewable raw materials is a further suitable dicarboxylic acid D for the purposes of the present invention. Furandicarboxylic acid at least partly derived from renewable raw materials is a further suitable dicarboxylic acid D for the purposes of the present invention. Tetrahydrofurandicarboxylic acid at least partly derived from renewable raw materials is a further suitable dicarboxylic acid D for the purposes of the present invention.

In a particularly preferred embodiment of the invention, the dicarboxylic acid D at least partly derived from natural raw materials is selected from the group consisting of sebacic acid, azelaic acid, dodecanedioic acid and succinic acid.

In a further preferred embodiment of the invention, the mixture used comprises sebacic acid derived from renewable raw materials.

In a further preferred embodiment of the invention, the mixture used comprises azelaic acid derived from renewable raw materials.

In a further embodiment, the present invention also provides polyurethane dispersions PUD comprising at least one polyurethane P based on sebacic acid at least partly derived from renewable raw materials.

In a further embodiment, the present invention also provides polyurethane dispersions PUD comprising at least one polyurethane P based on azelaic acid at least partly derived from renewable raw materials.

Further dicarboxylic acids D optionally employed in addition to a dicarboxylic acid D at least partly derived from renewable raw materials are also preferably selected from the group of C2 to C12 dicarboxylic acids. The aforementioned dicarboxylic acids plus particularly adipic acid are suitable.

In a further embodiment, the present invention also provides polyurethane dispersions PUD comprising at least one polyurethane P based on a mixture of two or more dicarboxylic acids D comprising sebacic acid at least partly derived from renewable raw materials and adipic acid. In a further embodiment, the present invention also provides polyurethane dispersions PUD comprising at least one polyurethane P based on a mixture of two or more dicarboxylic acids D comprising azelaic acid at least partly derived from renewable raw materials and adipic acid.

In one embodiment, it is also possible for the mixture to comprise, in addition to a sebacic acid at least partly derived from renewable raw materials, at least one further dicarboxylic acid D at least partly based on renewable raw materials. Accordingly, the mixture in a further embodiment of the present invention comprises two dicarboxylic acids D both at least partly derived from renewable raw materials.

For example, the mixture of two or more dicarboxylic acids D may comprise at least sebacic acid and adipic acid, in which case it is also possible for both the sebacic acid and the adipic acid to be at least partly derived from renewable raw materials.

The extent to which the mixture of two or more dicarboxylic acids D consists of sebacic acid and adipic acid is preferably not less than 90 wt %, more preferably from 95 to 100 wt % and most preferably from 98 to 99.99 wt %.

The extent to which the mixture of two or more dicarboxylic acids D consists of azelaic acid and adipic acid is preferably not less than 90 wt %, more preferably from 95 to 100 wt % and most preferably from 98 to 99.99 wt %.

The mixing ratio between the dicarboxylic acids D employed in the mixture may vary between wide limits. Expressed in mol % for the two or more dicarboxylic acids D, this mixing ratio may in a preferred embodiment be in the range from 90:10 to 10:90, more preferably from 80:20 to 20:80 and most preferably from 70:30 to 30:70.

In a more preferable embodiment, the mixing ratio in mol % between the dicarboxylic acids D sebacic acid and adipic acid is in the range from 90:10 to 10:90, more preferably from 80:20 to 20:80 and most preferably from 70:30 to 30:70.

In a more preferable embodiment, the mixing ratio in mol % between the dicarboxylic acids D azelaic acid and adipic acid is in the range from 90:10 to 10:90, more preferably from 80:20 to 20:80 and most preferably from 70:30 to 30:70.

In one embodiment, the at least one dicarboxylic acid D used and preferably also the polyhydric alcohol A used are preferably at least partly derived from renewable raw materials. Here at least partly is to be understood as meaning in the context of the present invention that the corresponding dicarboxylic acid D or the alcohol A was derived from renewable raw materials to an extent of not less than 25%, particularly that they were derived from renewable raw materials to an extent in the range from 50 to 100%, more preferably in the range from 75 to 100%, yet more preferably in the range from 85 to 100% and most preferably in the range from 95% to 100%.

In a further embodiment of the present invention, the polyester polyols PES are prepared using at least one dicarboxylic acid D and at least polyhydric alcohol A which were each at least partly derived from renewable raw materials.

Processes for preparing polyester polyols PES by polycondensation reaction of the corresponding hydroxyl compounds with dicarboxylic acids D preferably at elevated temperature and reduced pressure preferably in the presence of known catalysts are common general knowledge and have been extensively described.

Processes for preparing polyurethanes P are likewise common general knowledge. For example, polyurethanes P are obtainable by reaction of isocyanates with polyester polyol and optionally chain-extending agents having a molecular weight of 50 to 499 g/mol in the presence or absence of catalysts and/or customary assistants.

The ratio of the components employed may in principle vary between wide limits. This ratio of the components employed is typically described by the ratio of NCO groups to OH groups, the OH groups being the sum total of the OH groups for the employed polyester polyol PES, chain extender and any further additives.

The ratio of NCO to OH groups in the present invention is in the range from 0.9 to 1.1 for example and is preferably in the range from 0.95 to 1.05.

In the present invention, polyurethanes P are prepared by reacting the isocyanate with the polyester polyol PES and optionally further isocyanate-reactive compounds and optionally chain-extending agents in the presence or absence of catalysts and/or customary assistants.

The preparation of the polyurethane P may also proceed via the intermediate stage of prepolymers.

Useful organic isocyanates include the polyisocyanates customarily used in polyurethane dispersion chemistry, for example aliphatic, aromatic and cycloaliphatic di- and polyisocyanates, wherein the hydrocarbon moieties are for example of 4 to 12 carbon atoms when aliphatic, of 6 to 15 carbon atoms when cycloaliphatic or aromatic or of 7 to 15 carbon atoms when araliphatic, with an NCO functionality of not less than 1.8, preferably 1.8 to 5 and more preferably 2 to 4, and also their isocyanurates, biurets, allophanates and uretdiones.

The diisocyanates are preferably isocyanates having 4 to 20 carbon atoms. Examples of customary diisocyanates include aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetra-decamethylene diisocyanate, esters of lysine diisocyanate, tetramethylxylylene diisocyanate, trimethylhexane diisocyanate or tetramethylhexane diisocyanate, cycloaliphatic diisocyanates such as 1,4-, 1,3- or 1,2-diisocyanatocyclohexane, the trans/trans-, the cis/cis- and the cis/trans isomers of 4,4′- or 2,4′-di(isocyanatocyclo-hexyl)methane, 1-isocyanato-3,3,5-trimethyl-5-(isocyanatomethyl)cyclohexane (isophorone diisocyanate), 2,2-bis(4-isocyanatocyclohexyl)propane, 1,3- or 1,4-bis(isocyanatomethyl)cyclohexane or 2,4- or 2,6-diisocyanato-1-methylcyclohexane and also aromatic diisocyanates such as 2,4- or 2,6-tolylene diisocyanate and mixtures thereof, m- or p-xylylene diisocyanate, 2,4′- or 4,4′-diisocyanatodiphenylmethane and mixtures thereof, 1,3- or 1,4-phenylene diisocyanate, 1-chloro-2,4-phenylene diisocyanate, 1,5-naphthylene diisocyanate, biphenylylene 4,4′-diisocyanate, 4,4′-diisocyanato-3,3′-dimethylbiphenyl, 3-methyldiphenylmethane 4,4′-diisocyanate, 1,4-diisocyanatobenzene or oxydiphenyl 4,4′-diisocyanate.

The recited diisocyanates may also be present as mixtures.

Preference is given to aliphatic and cycloaliphatic diisocyanates, particular preference is given to isophorone diisocyanate, hexamethylene diisocyanate, meta-tetramethylxylylene diisocyanate (m-TMXDI) and 1,1-methylenebis[4-isocyanato]-cyclohexane (H₁₂MDI).

Useful polyisocyanates include polyisocyanates comprising isocyanurate groups, uretdiones diisocyanates, polyisocyanates comprising biuret groups, polyisocyanates comprising urethane or allophanate groups, polyisocyanates comprising oxadiazinetrione groups, uretoneimine-modified polyisocyanates of linear or branched C₄-C₂₀ alkylene diisocyanates, cycloaliphatic diisocyanates having altogether 6 to 20 carbon atoms or aromatic diisocyanates having altogether 8 to 20 carbon atoms or mixtures thereof.

The isocyanate group content (reckoned as NCO, equivalent weight=42 g/mol) of useful di- and polyisocyanates is preferably in the range from 10 to 60 wt % based on the di- and polyisocyanate (mixture), preferably from 15 to 60 wt % and more preferably from 20 to 55 wt %.

Preference is given to aliphatic/cycloaliphatic di- and polyisocyanates, for example the aforementioned aliphatic/cycloaliphatic diisocyanates, or mixtures thereof.

Preference is further given to
1) polyisocyanates of aromatic, aliphatic and/or cycloaliphatic diisocyanates and comprising isocyanurate groups. Particular preference here is given to the corresponding aliphatic and/or cycloaliphatic isocyanatoisocyanurates and especially to those based on hexamethylene diisocyanate and isophorone diisocyanate. The isocyanurates present here are more particularly tris-isocyantoalkyl or tris-isocyanatocycloalkyl isocyanurates, which are cyclic trimers of the diisocyanate, or mixtures with their higher homologs having more than one isocyanurate ring. Isocyanatoisocyanurates generally have an NCO content of 10 to 30 wt %, especially 15 to 25 wt % and an average NCO functionality of 3 to 4.5;
2) uretdione diisocyanates having aromatically, aliphatically and/or cycloaliphatically bound isocyanate groups, preferably aliphatically and/or cycloaliphatically bound ones and especially those deriving from hexamethylene diisocyanate or isophorone diisocyanate. Uretdione diisocyanates are cyclic dimerization products of diisocyanates.
   Uretdione diisocyanates are employable in the compositions as sole component or in admixture with other polyisocyanates, especially those recited under 1);
3) polyisocyanates comprising biuret groups and having aromatically, cycloaliphatically or aliphatically bound, preferably cycloaliphatically or aliphatically bound isocyanate groups, especially tris(6-isocyanatohexyl) biuret or its mixtures with its higher homologs. These polyisocyanates comprising biuret groups generally have an NCO content of 18 to 22 wt % and an average NCO functionality of 3 to 4.5;
4) polyisocyanates comprising urethane and/or allophanate groups and having aromatically, aliphatically or cycloaliphatically bound, preferably aliphatically or cycloaliphatically bound isocyanate groups, as obtainable for example by reaction of excess amounts of hexamethylene diisocyanate or of isophorone diisocyanate with polyhydric alcohols such as, for example, trimethylolpropane, neopentyl glycol, pentaerythritol, 1,4-butanediol, 1,6-hexanediol, 1,3-propanediol, ethylene glycol, diethylene glycol, glycerol, 1,2-dihydroxypropane or mixtures thereof. These polyisocyanates comprising urethane and/or allophanate groups generally have an NCO content of 12 to 20 wt % and an average NCO functionality of 2.5 to 3;
5) polyisocyanates comprising oxadiazinetrione groups and preferably deriving from hexamethylene diisocyanate or isophorone diisocyanate. Such polyisocyanates comprising oxadiazinetrione groups are synthesizable from diisocyanate and carbon dioxide;
6) uretoneimine-modified polyisocyanates.

The polyisocyanates 1) to 6) are employable in admixture, optionally also in admixture with diisocyanates.

Useful mixtures of these isocyanates include particularly the mixtures of the respective structural isomers of diisocyanatotoluene and diisocyanatodiphenylmethane in that the mixture formed from 20 mol % of 2,4-diisocyanatotoluene and 80 mol % of 2,6-diisocyanatotoluene is suitable in particular. It is further the case that mixtures of aromatic isocyanates such as 2,4-diisocyanatotoluene and/or 2,6-diisocyanatotoluene with aliphatic or cycloaliphatic isocyanates such as hexamethylene diisocyanate or IPDI are particularly advantageous, the preferred mixing ratio of aliphatic isocyanates to aromatic isocyanates being in the range from 4:1 to 1:4.

Useful compounds (a) also include isocyanates which in addition to free isocyanate groups bear further blocked isocyanate groups, for example uretdione or urethane groups.

It is optionally also possible to co-use such isocyanates as bear but one isocyanate group. Their proportion generally does not exceed 10 mol %, based on total moles of monomers. Said monoisocyanates typically bear further functional groups such as olefinic groups or carbonyl groups and serve to introduce functional groups into the polyurethane which enable the dispersal/crosslinking or further polymer-analogous conversion of the polyurethane. Monomers such as isopropenyl α,α-dimethylbenzyl isocyanate (TMI) are useful for this.

Useful chain extenders include commonly known aliphatic, araliphatic, aromatic and/or cycloaliphatic compounds having a molecular weight of 50 to 499 g/mol, preferably 2-functional compounds, examples being alkanediols having 2 to 10 carbon atoms in the alkylene radical, preferably 1,4-butanediol, 1,6-hexanediol and/or di-, tri-, tetra-, penta-, hexa-, hepta-, octa-, nona- and/or decaalkylene glycols of 3 to 8 carbon atoms, preferably unbranched alkanediols, more particularly 1,3-propanediol and 1,4-butanediol.

In one embodiment it is preferable for the chain extender to be selected from the group consisting of aliphatic C2-C6 diols, more preferably from the group consisting of 1,3-propanediol, 1,4-butanediol and 1,6-hexanediol.

In a further embodiment, the present invention also provides polyurethane dispersions PUD comprising at least one polyurethane P as described above wherein the at least one chain extender is selected from the group consisting of C2 to C6 diols.

It is further preferable for the purposes of the present invention for the chain extender used to be at least partly derived from renewable raw materials. It is possible for the purposes of the present invention for the chain extender used to be partly or wholly derived from renewable raw materials.

In one embodiment, therefore, the chain extender is selected from the group consisting of 1,3-propanediol and 1,3-propanediol at least partly derived from renewable raw materials.

In a further embodiment, the at least one dicarboxylic acid D and the at least one polyhydric alcohol A employed for preparing the polyester polyols PES and the chain extender used have each been at least partly derived from renewable raw materials.

Useful chain extenders further include amines bearing more than 2 isocyanate-reactive amino groups. Preferred amines for use as chain extenders are polyfunctional amines in the molecular weight range from 32 to 500 g/mol, preferably from 60 to 300 g/mol, which comprise at least two primary, two secondary or at least one primary and one secondary amino group. Examples thereof are diamines such as diaminoethane, diaminopropanes, diaminobutanes, diaminohexanes, piperazine, 2,5-dimethyl-piperazine, amino-3-aminomethyl-3,5,5-trimethylcyclohexane (isophoronediamine, IPDA), 4,4′-diaminodicyclohexylmethane, 1,4-diaminocyclohexane, aminoethylethanol-amine, hydrazine, hydrazine hydrate or triamines such as diethylenetriamine or 1,8-diamino-4-aminomethyloctane or higher amines such as triethylenetetramine, tetraethylenepentamine or polymeric amines such as polyethyleneamines, hydrogenated polyacrylonitriles or at least partially hydrolyzed poly-N-vinylformamides, each with a molecular weight up to 2000 and preferably up to 1000 g/mol.

The amines may be used in blocked form, for example in the form of the corresponding ketimines (see for instance CA-1 129 128), ketazines (cf. for instance U.S. Pat. No. 4,269,748) or amine salts (see U.S. Pat. No. 4,292,226). Oxazolidines as used for instance in U.S. Pat. No. 4,192,937 also represent blocked polyamines useful in the manufacture of polyurethanes to chain extend the prepolymers. When blocked polyamines of this type are used, they are generally mixed with the prepolymers in the absence of water and this mixture is subsequently mixed with the dispersion water, or some of the dispersion water, to liberate the corresponding polyamines by hydrolysis.

Preference is given to using mixtures of di- and triamines, more preferably mixtures of isophoronediamine and diethylenetriamine.

In one embodiment, the present invention also provides polyurethane dispersions PUD comprising at least one polyurethane P as described above wherein the at least one chain extender is selected from the group of amines bearing more than 2 isocyanate-reactive amino groups.

Suitable catalysts for speeding in particular the reaction between the NCO groups of the polyisocyanates and the polyol component are the customary compounds which are known from the prior art and are derivable from the literature. Examples of suitable catalysts in the context of the present invention are tertiary amines, for example triethylamine, dimethylcyclohexylamine, N-methylmorpholine, N,N′-dimethyl-piperazine, 2-(dimethylaminoethoxy)ethanol, diazabicyclo (2,2,2)octane and the like and also, more particularly, organic metal compounds such as titanic esters, iron compounds such as, for example, iron(III) acetylacetonate, tin compounds, for example tin diacetate, tin dioctoate, tin dilaurate or the tin dialkyl salts of aliphatic carboxylic acids such as dibutyltin diacetate, dibutyltin dilaurate or the like. The catalysts are customarily used in amounts of 0.00001 to 0.1 part by weight per 100 parts by weight of polyhydroxy compound.

In addition to catalysts, the synthon components, i.e., the polyols, isocyanates and chain extenders, may also have added to them customary auxiliaries. Examples are surface-active substances, flame retardants, nucleating agents, lubricating and demolding aids, dyes and pigments, stabilizers, for example against hydrolysis, light, heat or discoloration, inorganic and/or organic fillers, reinforcing agents and metal deactivators. To stabilize the polyurethane of the present invention against aging, the polyurethane preferably has stabilizers added to it. Stabilizers for the purposes of the present invention are additives which protect a plastic or a plastic mixture against harmful environmental effects. Examples are primary and secondary antioxidants, thiosynergists, organophosphorus compounds of trivalent phosphorus, hindered amine light stabilizers, UV absorbers, hydrolysis control agents, quenchers and flame retardants. Examples of commercial stabilizers are given in Plastics Additive Handbook, 5th Edition, H. Zweifel, ed., Hanser Publishers, Munich, 2001, p.98-p.136. When the polyurethane of the present invention is exposed to thermal oxidative damage, during its use, antioxidants can be added. Preference is given to using phenolic antioxidants. Examples of phenolic antioxidants are given in Plastics Additive Handbook, 5th edition, H. Zweifel, ed, Hanser Publishers, Munich, 2001, pp. 98-107 and p.116-p.121. Preference is given to phenolic antioxidants having a molecular weight greater than 700 g/mol. One example of a phenolic antioxidant which is preferably used is pentaerythrityl tetrakis (3-(3,5-bis(1,1-dimethylethyl)-4-hydroxyphenyl)propionate) (Irganox® 1010) or other high molecular weight condensation products formed from corresponding antioxidants. The phenolic antioxidants are generally used in concentrations of between 0.1% and 5% by weight, preferably between 0.1% and 2% by weight and especially between 0.5% and 1.5% by weight, all based on the total weight of the polyurethane. Preference is further given to using antioxidants which are amorphous or liquid. Even though the polyurethanes of the present invention are by virtue of their preferable composition distinctly more stable to ultraviolet radiation than, for example, polyurethanes plasticized with phthalates or benzoates, stabilization with phenolic stabilizers only is often insufficient. For this reason, the polyurethanes of the present invention which are exposed to UV light are preferably additionally stabilized with a UV absorber. UV absorbers are molecules which absorb high energy UV light and dissipate the energy. UV absorbers widely used in industry belong for example to the group of the cinnamic esters, the diphenyl cyanoacrylates, the oxamides (oxanilides), more particularly 2-ethoxy-2′-ethyloxanilide, the formamidines, the benzylidenemalonates, the diarylbutadienes, triazines and also the benzotriazoles. Examples of commercial UV absorbers are given in Plastics Additive Handbook, 5th edition, H. Zweifel, ed, Hanser Publishers, Munich, 2001 pp. 116-122. In a preferred embodiment, the UV absorbers have a number average molecular weight greater than 300 g/mol and more particularly greater than 390 g/mol. Furthermore, the UV absorbers which are preferably used should have a molecular weight of not greater than 5000 g/mol and more preferably of not greater than 2000 g/mol. The group of the benzotriazoles is particularly useful as UV absorbers. Examples of particularly useful benzotriazoles are Tinuvin® 213, Tinuvin® 328, Tinuvin® 571, and also Tinuvin® 384 and Eversorb® 82. The UV absorbers are preferably added in amounts between 0.01% and 5% by weight, based on the total mass of polyurethane, more preferably between 0.1% and 2.0% by weight and especially between 0.2% and 0.5% by weight, all based on the total weight of the polyurethane. Often, an above-described UV stabilization based on an antioxidant and a UV absorber is still not sufficient to ensure good stability for the polyurethane of the present invention against the harmful influence of UV rays. In this case, a hindered amine light stabilizer (HALS) can preferably be added in addition to the antioxidant and the UV absorber. A particularly preferred UV stabilization comprises a mixture of a phenolic stabilizer, a benzotriazole and a HALS compound in the above-described preferred amounts. However, it is also possible to use compounds which combine the functional groups of the stabilizers, for example sterically hindered piperidylhydroxybenzyl condensation products such as for example di(1,2,2,6,6-pentamethyl-4-piperidyl) 2-butyl-2-(3,5-di-tert-butyl-4-hydroxybenzyl) malonate, Tinuvin® 144.

The invention further provides processes for preparing a polyurethane dispersion PUD which comprise the step of reacting at least one polyisocyanate and at least one polyester polyol PES, wherein the polyester polyol PES is based on at least one polyhydric alcohol A and at least one dicarboxylic acid D, wherein at least one polyhydric alcohol A and/or at least one dicarboxylic acid D were at least partly derived from renewable raw materials.

The present invention further provides a process for preparing aqueous polyurethane dispersions PUD wherein the aqueous polyurethane dispersions are prepared as follows:
I. preparing a polyurethane by reaction of
   a) at least one polyfunctional isocyanate having 4 to 30 carbon atoms,
   b) diols whereof
   b1) 10 to 100 mol %, based on the total amount of diols (b), have a molecular weight of 500 to 5000, and
   b2) 0 to 90 mol %, based on the total amount of diols (b), have a molecular weight of 60 to 500 g/mol,
   c) optionally further polyfunctional compounds other than the diols (b) and having reactive groups in the form of alcoholic hydroxyl groups or primary or secondary amino groups, and
   d) monomers having at least an isocyanate group or at least an isocyanate-reactive group which are other than the monomers (a), (b) and (c) and which further bear at least a hydrophilic group or a potentially hydrophilic group, whereby polyurethanes are rendered dispersible in water,
to form a polyurethane in the presence of a solvent S, and
II. then dispersing the polyurethane in water,
III. wherein polyamines may optionally be added after or during step II,
   wherein diol b), preferably b1) comprises at least one polyester polyol PES based on at least one polyhydric alcohol A and at least one dicarboxylic acid D, wherein at least one polyhydric alcohol A and/or at least one dicarboxylic acid D were at least partly derived from renewable raw materials.

Useful solvents S include, for example, acetone, methyl ethyl ketone, N-(cyclo)alkyl-pyrrolidones such as N-methylpyrrolidone (NMP), N-ethylpyrrolidone (NEP) or N-cyclo-hexylpyrrolidone; N-acylmorpholines such as formylmorpholine or acetylmorpholione, dioxolanes such as 1,3-dioxolane, tetrahydrofuran.

Useful monomers in (a) include the polyisocyanates customarily used in polyurethane dispersion chemistry, for example aliphatic, aromatic and cycloaliphatic di- and polyisocyanates, wherein the hydrocarbon moieties are for example of 4 to 12 carbon atoms when aliphatic, of 6 to 15 carbon atoms when cycloaliphatic or aromatic or of 7 to 15 carbon atoms when araliphatic, with an NCO functionality of not less than 1.8, preferably 1.8 to 5 and more preferably 2 to 4, and also their isocyanurates, biurets, allophanates and uretdiones.

The diisocyanates are preferably isocyanates having 4 to 20 carbon atoms. Examples of customary diisocyanates include aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetra-decamethylene diisocyanate, esters of lysine diisocyanate, tetramethylxylylene diisocyanate, trimethylhexane diisocyanate or tetramethylhexane diisocyanate, cycloaliphatic diisocyanates such as 1,4-, 1,3- or 1,2-diisocyanatocyclohexane, the trans/trans-, the cis/cis- and the cis/trans isomers of 4,4′- or 2,4′-di(isocyanatocyclo-hexyl)methane, 1-isocyanato-3,3,5-trimethyl-5-(isocyanatomethyl)cyclohexane (isophorone diisocyanate), 2,2-bis(4-isocyanatocyclohexyl)propane, 1,3- or 1,4-bis(isocyanatomethyl)cyclohexane or 2,4- or 2,6-diisocyanato-1-methylcyclohexane and also aromatic diisocyanates such as 2,4- or 2,6-tolylene diisocyanate and isomer mixtures thereof, m- or p-xylylene diisocyanate, 2,4′- or 4,4′-diisocyanatodiphenylmethane and isomer mixtures thereof, 1,3- or 1,4-phenylene diisocyanate, 1-chloro-2,4-phenylene diisocyanate, 1,5-naphthylene diisocyanate, biphenylylene 4,4′-diisocyanate, 4,4′-diisocyanato-3,3′-dimethylbiphenyl, 3-methyldiphenylmethane 4,4′-diisocyanate, 1,4-diisocyanatobenzene or oxydiphenyl 4,4′-diisocyanate.

The recited diisocyanates may also be present as mixtures.

Preference is given to aliphatic and cycloaliphatic diisocyanates, particular preference is given to isophorone diisocyanate, hexamethylene diisocyanate, meta-tetramethylxylylene diisocyanate (m-TMXDI) and 1,1-methylenebis[4-isocyanato]-cyclohexane (H₁₂MDI).

Useful polyisocyanates include polyisocyanates comprising isocyanurate groups, uretdiones diisocyanates, polyisocyanates comprising biuret groups, polyisocyanates comprising urethane or allophanate groups, polyisocyanates comprising oxadiazinetrione groups, uretoneimine-modified polyisocyanates of linear or branched C₄-C₂₀ alkylene diisocyanates, cycloaliphatic diisocyanates having altogether 6 to 20 carbon atoms or aromatic diisocyanates having altogether 8 to 20 carbon atoms or mixtures thereof.

The isocyanate group content (reckoned as NCO, equivalent weight=42 g/mol) of useful di- and polyisocyanates is preferably in the range from 10 to 60 wt % based on the di- and polyisocyanate (mixture), preferably from 15 to 60 wt % and more preferably from 20 to 55 wt %.

Preference is given to aliphatic/cycloaliphatic di- and polyisocyanates, for example the aforementioned aliphatic/cycloaliphatic diisocyanates, or mixtures thereof.

Preference is further given to
1) polyisocyanates of aromatic, aliphatic and/or cycloaliphatic diisocyanates and comprising isocyanurate groups. Particular preference here is given to the corresponding aliphatic and/or cycloaliphatic isocyanatoisocyanurates and especially to those based on hexamethylene diisocyanate and isophorone diisocyanate. The isocyanurates present here are more particularly tris-isocyantoalkyl or tris-isocyanatocycloalkyl isocyanurates, which are cyclic trimers of the diisocyanate, or mixtures with their higher homologs having more than one isocyanurate ring. Isocyanatoisocyanurates generally have an NCO content of 10 to 30 wt %, especially 15 to 25 wt % and an average NCO functionality of 3 to 4.5;
2) uretdione diisocyanates having aromatically, aliphatically and/or cycloaliphatically bound isocyanate groups, preferably aliphatically and/or cycloaliphatically bound ones and especially those deriving from hexamethylene diisocyanate or isophorone diisocyanate. Uretdione diisocyanates are cyclic dimerization products of diisocyanates.
   Uretdione diisocyanates are employable in the compositions as sole component or in admixture with other polyisocyanates, especially those recited under 1);
3) polyisocyanates comprising biuret groups and having aromatically, cycloaliphatically or aliphatically bound, preferably cycloaliphatically or aliphatically bound isocyanate groups, especially tris(6-isocyanatohexyl) biuret or its mixtures with its higher homologs. These polyisocyanates comprising biuret groups generally have an NCO content of 18 to 22 wt % and an average NCO functionality of 3 to 4.5;
4) polyisocyanates comprising urethane and/or allophanate groups and having aromatically, aliphatically or cycloaliphatically bound, preferably aliphatically or cycloaliphatically bound isocyanate groups, as obtainable for example by reaction of excess amounts of hexamethylene diisocyanate or of isophorone diisocyanate with polyhydric alcohols such as, for example, trimethylolpropane, neopentyl glycol, pentaerythritol, 1,4-butanediol, 1,6-hexanediol, 1,3-propanediol, ethylene glycol, diethylene glycol, glycerol, 1,2-dihydroxypropane or mixtures thereof. These polyisocyanates comprising urethane and/or allophanate groups generally have an NCO content of 12 to 20 wt % and an average NCO functionality of 2.5 to 3;
5) polyisocyanates comprising oxadiazinetrione groups and preferably deriving from hexamethylene diisocyanate or isophorone diisocyanate. Such polyisocyanates comprising oxadiazinetrione groups are synthesizable from diisocyanate and carbon dioxide;
6) uretoneimine-modified polyisocyanates.

The polyisocyanates 1) to 6) are employable in admixture, optionally also in admixture with diisocyanates.

Useful mixtures of these isocyanates include particularly the mixtures of the respective structural isomers of diisocyanatotoluene and diisocyanatodiphenylmethane in that the mixture formed from 20 mol % of 2,4-diisocyanatotoluene and 80 mol % of 2,6-diisocyanatotoluene is suitable in particular. It is further the case that mixtures of aromatic isocyanates such as 2,4-diisocyanatotoluene and/or 2,6-diisocyanatotoluene with aliphatic or cycloaliphatic isocyanates such as hexamethylene diisocyanate or IPDI are particularly advantageous, the preferred mixing ratio of aliphatic isocyanates to aromatic isocyanates being in the range from 4:1 to 1:4.

Useful compounds (a) also include isocyanates which in addition to free isocyanate groups bear further blocked isocyanate groups, for example uretdione or urethane groups.

It is optionally also possible to co-use such isocyanates as bear but one isocyanate group. Their proportion generally does not exceed 10 mol %, based on total moles of monomers. Said monoisocyanates typically bear further functional groups such as olefinic groups or carbonyl groups and serve to introduce functional groups into the polyurethane which enable the dispersal/crosslinking or further polymer-analogous conversion of the polyurethane. Monomers such as isopropenyl α,α-dimethylbenzyl isocyanate (TMI) are useful for this.

Useful diols (b) include primarily comparatively high molecular weight diols (b1) having a molecular weight of about 500 to 5000 and preferably of about 100 to 3000 g/mol.

The diols (b1) are more particularly polyester polyols as known for example from Ullmanns Encyklopädie der technischen Chemie, 4th edition, volume 19, pages 62 to 65. Preference is given to using polyester polyols obtained by reaction of dihydric alcohols A with dibasic carboxylic acids D. Instead of the free polycarboxylic acids, it is also possible to use the corresponding polycarboxylic anhydrides or corresponding polycarboxylic esters of lower alcohols, or mixtures thereof, to prepare the polyester polyols. The polycarboxylic acids may be aliphatic, cycloaliphatic, araliphatic, aromatic or heterocyclic and may optionally be substituted, by halogen atoms for example, and/or unsaturated. Examples thereof are suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimeric fatty acids. Preference is given to dicarboxylic acids of the general formula HOOC—(CH₂)_{y}—COOH, where y is from 1 to 20 and preferably an even number from 2 to 20, examples being succinic acid, adipic acid, dodecanedicarboxylic acid and sebacic acid.

Useful polyhydric alcohols A include for example ethylene glycol, 1,2-propanediol, 1,3-propanediol, 1,3-butanediol, 1,4-butenediol, 1,4-butinediol, 1,5-pentanediol, neopentyl glycol, bis(hydroxymethyl)cyclohexanes such as 1,4-bis(hydroxymethyl)-cyclohexane, 2-methylpropane-1,3-diol, further diethylene glycol, triethylene glycol, tetraethylene glycol, polyethylene glycol, dipropylene glycol, polypropylene glycol, dibutylene glycol and polybutylene glycols. Preference is given to neopentyl glycol and also alcohols of the general formula HO—(CH₂)ₓ—OH, where x is from 1 to 20 and preferably an even number from 2 to 20. Examples thereof are ethylene glycol, 1,4-butanediol, 1,6-hexanediol, 1,8-octanediol and 1,12-dodecanediol.

Possibilities further include polycarbonate diols as obtainable for example by reaction of phosgene with an excess of the low molecular weight alcohols recited as synthon components for the polyester polyols.

Lactone-based polyester diols are also suitable, i.e., homo- or copolymers of lactones, preferably terminally hydroxylated addition products of lactones onto suitable difunctional starter molecules. Preferred lactones derive from hydroxyl carboxylic acids of the general formula HO—(CH₂)_{z}—COOH, where z is from 1 to 20 and preferably an odd number from 3 to 19, examples being ε-caprolactone, β-propiolactone, γ-butyrolactone and/or methyl-ε-caprolactone and also mixtures thereof. Suitable starter components include, for example, the low molecular weight dihydric alcohols recited above as synthon component for the polyester polyols. The corresponding polymers of ε-caprolactone are particularly preferable. Lower polyester diols or polyether diols can also be used as starters for preparing the lactone polymers. Instead of polymers of lactones, it is also possible to use the corresponding, chemically equivalent polycondensates of the hydroxy carboxylic acids corresponding to the lactones.

Useful monomers (b1) further include polyether diols. They are obtainable, in particular, by polymerization of ethylene oxide, propylene oxide, butylene oxide, tetrahydrofuran, styrene oxide or epichlorohydrin with itself, for example in the presence of BF₃ or by addition reaction of these compounds, optionally in a mixture or in succession, onto starter components having reactive hydrogen atoms, such as alcohols or amines, e.g., water, ethylene glycol, 1,2-propanediol, 1,3-propanediol, 2,2-bis(4-hydroxydiphenyl)-propane or aniline. Polytetrahydrofuran having a molecular weight of 500 to 5000 g/mol and especially 1000 to 4500 g/mol is particularly preferable.

The polyester diols and polyether diols may also be used as mixtures in a ratio ranging from 0.1:1 to 1:9.

Useful diols (b) in addition to the diols (b1) further include low molecular weight diols (b2) having a molecular weight of about 50 to 500 and preferably of 60 to 200 g/mol.

Useful monomers (b2) include especially the synthon components of the short-chain alkanediols recited for the preparation of polyester polyols, preference being given to unbranched diols having 2 to 12 carbon atoms and an even number of carbon atoms and also 1,5-pentanediol and neopentyl glycol.

Diols (b1) and diols (b2) preferably comprise respectively from 10 to 100 mol % and from 0 to 90 mol % of the total amount of diols (b). The ratio of diols (b1) to diols (b2) is more preferably in the range from 0.2:1 to 5:1, more preferably from 0.5:1 to 2:1.

Suitable diols b), preferably b1), for the purposes of the present invention are at least partly polyester polyols PES based on at least one polyhydric alcohol A and at least one dicarboxylic acid D, wherein at least one polyhydric alcohol A and/or at least one dicarboxylic acid D were at least partly derived from renewable raw materials, as described above.

The diols b), preferably b1), used in one embodiment are at least 10 wt %, preferably at least 30 wt %, more preferably at least 50 wt %, yet more preferably at least 70 wt % and most preferably at least 90 wt % polyester polyols PES based on at least one polyhydric alcohol A and at least one dicarboxylic acid D, wherein at least one polyhydric alcohol A and/or at least one dicarboxylic acid D were at least partly derived from renewable raw materials.

The diols b), preferably b1), used in one embodiment are exclusively polyester polyols PES based on at least one polyhydric alcohol A and at least one dicarboxylic acid D, wherein at least one polyhydric alcohol A and/or at least one dicarboxylic acid D were at least partly derived from renewable raw materials.

The monomers (c), which differ from the diols (b), generally are designed to serve the purposes of crosslinking or of chain extension. Generally they are more than dihydric nonaromatic alcohols, amines having 2 or more primary and/or secondary amino groups, and also compounds which in addition to one or more alcoholic hydroxyl groups bear one or more primary and/or secondary amino groups.

Alcohols having a higher hydricness than 2, which are useful for establishing a certain degree of branching or crosslinking include, for example, trimethylolbutane, trimethylolpropane, trimethylolethane, pentaerythritol, glycerol, sugar alcohols, e.g., sorbitol, mannitol, diglycerol, threitol, erythritol, adonitol (ribitol), arabitol (lyxitol), xylitol, dulcitol (galactitol), maltitol or isomalt, or sugar.

It is further possible to use monoalcohols which as well as the hydroxyl group bear a further isocyanate-reactive group, such as monoalcohols having one or more primary and/or secondary amino groups, for example monoethanolamine.

Polyamines having 2 or more primary and/or secondary amino groups are useful in the prepolymer mixing process especially when the crosslinking or chain extension is to take place in the presence of water (step III), since amines generally react faster with isocyanates than do alcohols or water. This is frequently necessary whenever aqueous dispersions of crosslinked polyurethanes or polyurethanes of high molecular weight are desired. In such cases, prepolymers having isocyanate groups are prepared, rapidly dispersed in water and subsequently crosslinked or chain extended by admixture of compounds having two or more isocyanate-reactive amino groups.

Amines suitable for this purpose are generally polyfunctional amines of the molecular weight range from 32 to 500 g/mol, preferably from 60 to 300 g/mol, which comprise at least two primary, at least two secondary or at least one primary and one secondary amino group. Examples thereof are diamines such as diaminoethane, diaminopropanes, diaminobutanes, diaminohexanes, piperazine, 2,5-dimethyl-piperazine, amino-3-aminomethyl-3,5,5-trimethylcyclohexane (isophoronediamine, IPDA), 4,4′-diaminodicyclohexylmethane, 1,4-diaminocyclohexane, aminoethylethanol-amine, hydrazine, hydrazine hydrate or triamines such as diethylenetriamine or 1,8-diamino-4-aminomethyloctane or higher amines such as triethylenetetramine, tetraethylenepentamine or polymeric amines such as polyethyleneamines, hydrogenated polyacrylonitriles or at least partially hydrolyzed poly-N-vinylformamides, each with a molecular weight up to 2000 and preferably up to 1000 g/mol.

The amines may be used in blocked form, for example in the form of the corresponding ketimines (see for instance CA-1 129 128), ketazines (cf. for instance U.S. Pat. No. 4,269,748) or amine salts (see U.S. Pat. No. 4,292,226). Oxazolidines as used for instance in U.S. Pat. No. 4,192,937 also represent blocked polyamines useful in the manufacture of polyurethanes to chain extend the prepolymers. When blocked polyamines of this type are used, they are generally mixed with the prepolymers in the absence of water and this mixture is subsequently mixed with the dispersion water, or some of the dispersion water, to liberate the corresponding polyamines by hydrolysis.

Preference is given to using mixtures of di- and triamines, more preferably mixtures of isophoronediamine and diethylenetriamine.

The proportion of polyamines may be up to 10, preferably up to 8 mol % and more preferably up to 5 mol %, based on the total amount of components (b) and (c).

The polyurethane prepared in step I may generally comprise up to 10 wt %, preferably up to 5 wt % of unreacted NCO groups.

The molar ratio of NCO groups in the polyurethane prepared in step I to the sum total of primary and secondary amino groups in the polyamine is generally chosen in step III such that it is between 3:1 and 1:3, preferably 2:1 and 1:2, more preferably 1.5:1 and 1:1.5 and most preferably equal to 1:1.

It is further possible to use, for chain termination, minor amounts, i.e., preferably in amounts of less than 10 mol %, based on components (b) and (c), of monoalcohols. Their function is mainly to limit the molecular weight of the polyurethane. Examples are methanol, ethanol, isopropanol, n-propanol, n-butanol, isobutanol, sec-butanol, tert-butanol, ethylene glycol monomethyl ether, ethylene glycol monoethyl ether, 1,3-propanediol monomethyl ether, n-hexanol, n-heptanol, n-octanol, n-decanol, n-dodecanol (lauryl alcohol) and 2-ethylhexanol.

To render the polyurethanes dispersible in water, they are polymerized not only from components (a), (b) and (c) but also from monomers (d) other than components (a), (b) and (c) and bearing at least an isocyanate group or at least an isocyanate-reactive group and further at least a hydrophilic group or a group convertible into hydrophilic groups. In what follows, the term “hydrophilic groups or potentially hydrophilic groups” is abbreviated as “(potentially) hydrophilic groups”. The (potentially) hydrophilic groups are significantly slower to react with isocyanates than the functional groups of the monomers used to polymerize the polymer main chain. The (potentially) hydrophilic groups may be nonionic or preferably ionic, i.e., cationic or anionic, hydrophilic groups, or potentially ionic hydrophilic groups and more preferably anionic hydrophilic groups or potentially anionic hydrophilic groups.

The proportion of the total amount of components (a), (b), (c) and (d) which is attributable to components having (potentially) hydrophilic groups is generally determined such that the molar amount of the (potentially) hydrophilic groups is from 30 to 1000, preferably from 50 to 500 and more preferably from 80 to 300 mmol/kg, based on the weight of all monomers (a) to (b).

Suitable nonionic hydrophilic groups include, for example, mixed or straight polyethylene glycol ethers having preferably from 5 to 100 and more preferably from 10 to 80 ethylene oxide repeat units. The polyethylene glycol ethers may also comprise propylene oxide units. When that is the case, the propylene oxide unit content shall not exceed 50 wt %, preferably 30 wt %, based on the mixed polyethylene glycol ethers.

The polyethylene oxide unit content is generally from 0 to 10 and preferably from 0 to 6 wt %, based on the weight of all monomers (a) to (d).

Preferred monomers having nonionic hydrophilic groups are polyethylene glycol and diisocyanates bearing a terminally etherified polyethylene glycol moiety. Diisocyanates of this type and also their methods of making are disclosed in the patent documents U.S. Pat. No. 3,905,929 and U.S. Pat. No. 3,920,598.

Ionic hydrophilic groups are, in particular, anionic groups such as the sulfonate group, the carboxylate group and the phosphate group in the form of an alkali metal or ammonium salts and also cationic groups such as ammonium groups, especially protonated tertiary amino groups or quaternary ammonium groups.

The monomers used as having potentially anionic groups are typically aliphatic, cycloaliphatic, araliphatic or aromatic mono- and dihydroxy carboxylic acids which bear at least one alcoholic hydroxyl group or one primary or secondary amino group.

Such Compounds are for Example Represented by the General Formula

RG-R⁴-DG

where
RG is at least one isocyanate-reactive group
DG is at least one (potentially) hydrophilic group and
R⁴ is an aliphatic, cycloaliphatic or aromatic moiety comprising from 1 to 20 carbon atoms.

Examples of RG are —OH, —SH, —NH₂ or —NHR⁵, where R⁵ may be methyl, ethyl, isopropyl, n-propyl, n-butyl, isobutyl, sec-butyl, tert-butyl, cyclopentyl or cyclohexyl.

Components of this type are preferably, for example, mercaptoacetic acid, mercaptopropionic acid, thiolactic acid, mercaptosuccinic acid, glycine, iminodiacetic acid, sarcosine, alanine, β-alanine, leucine, isoleucine, aminobutyric acid, hydroxyacetic acid, hydroxypivalic acid, lactic acid, hydroxysuccinic acid, hydroxydecanoic acid, dimethylolpropionic acid, dimethylolbutyric acid, ethylenediaminetriacetic acid, hydroxydodecanoic acid, hydroxyhexadecanoic acid, 12-hydroxystearic acid, aminonaphthalenecarboxylic acid, hydroxyethanesulfonic acid, hydroxypropanesulfonic acid, mercaptoethanesulfonic acid, mercaptopropanesulfonic acid, aminomethanesulfonic acid, taurine, aminopropanesulfonic acid, N-cyclohexylaminepropanesulfonic acid, N-cyclohexylaminoethanesulfonic acid and also their alkali metal, alkaline earth metal or ammonium salts, and more preferably are the recited monohydroxy carboxylic and sulfonic acids and also monoamino carboxylic and sulfonic acids.

Very particular preference is given to dihydroxyalkylcarboxylic acids, particularly having 3 to 10 carbon atoms, as also described in U.S. Pat. No. 3,412,054. Especially compounds of the general formula

HO—R¹—CR³(COOH)—R²—OH

where R¹ and R² are each a C₁ to C₄ alkane diyl unit and R³ is a C₁ to C₄ alkyl unit, are preferred. Dimethylolbutyric acid and particularly dimethylolpropionic acid (DMPA) are particularly preferable.

Also suitable are the corresponding dihydroxy sulfonic acids and dihydroxy phosphonic acids such as 2,3-dihydroxypropanephosphonic acid and also the corresponding acids in which at least one hydroxyl group is replaced by an amino group, for example those of the formula

H₂N—R¹—CR³(COOH)—R²—NH₂

where R¹, R² and R³ are each as defined above.

It is otherwise possible to use dihydroxy compounds having a molecular weight above 500 to 10 000 g/mol and at least 2 carboxylic groups, which are known from DE-A 4 140 486. They are obtainable by reaction of dihydroxy compounds with tetracarboxylic dianhydrides such as pyromellitic dianhydride or cyclopentanetetra-carboxylic dianhydride in a molar ratio ranging from 2:1 to 1.05:1, in a polyaddition reaction. Suitable dihydroxy compounds include particularly the monomers (b2) recited as chain extenders and also the diols (b1).

Potentially ionic hydrophilic groups are particularly those which are convertible by simple neutralization, hydrolysis or quaternization reactions into the abovementioned ionic hydrophilic groups, i.e., for instance acid groups, anhydride groups or tertiary amino groups.

Ionic monomers (d) or potentially ionic monomers (d) have been extensively described, for example in Ullmanns Encyklopadie der technischen Chemie, 4th edition, volume 19, pages 311-313 and, for example, in DE-A 1 495 745.

For use as potentially cationic monomers (d) it is especially monomers that have tertiary amino groups which are of particular practical importance, examples being: tris(hydroxyalkyl)amines, N,N′-bis(hydroxyalkyl)alkylamines, N-hydroxyalkyl-dialkylamines, tris(aminoalkyl)amines, N,N′-bis(aminoalkyl)alkylamines, N-aminoalkyl-dialkylamines, wherein the alkyl moieties and alkanediyl units of these tertiary amines each independently consist of 2 to 6 carbon atoms. It is further possible to use polyethers having tertiary nitrogen atoms and preferably two terminal hydroxyl groups, obtainable in a conventional manner by, for example, alkoxylation of amines having two hydrogen atoms bonded to amine nitrogen, examples being methylamine, aniline or N,N′-dimethylhydrazine. Polyethers of this type generally have a molecular weight in the range from 500 to 6000 g/mol.

These tertiary amines are converted into ammonium salts either with acids, preferably strong mineral acids such as phosphoric acid, sulfuric acid, or hydrohelic acids, strong organic acids, for example formic acid, acetic acid or lactic acid, or by reaction with suitable quaternizing agents such as C₁ to C₆ alkyl halides, e.g., bromides or chlorides, or di-C₁ to C₆ alkyl sulfates or di-C₁ to C₆ alkyl carbonates.

Useful monomers (d) having isocyanate-reactive amino groups include amino carboxylic acids such as lysine, β-alanine, the adducts mentioned in DE-A2034479 of aliphatic diprimary diamines onto α,β-unsaturated carboxylic acids such as N-(2-aminoethyl)-2-aminoethanecarboxylic acid and also the corresponding N-aminoalkylaminoalkylcarboxylic acids, wherein the alkanediyl units consist of 2 to 6 carbon atoms.

When monomers having potentially ionic groups are used, their conversion into the ionic form may be effected before, during, but preferably after the isocyanate polyaddition reaction, since the ionic monomers are frequently only sparingly soluble in the reaction mixture. The anionic hydrophilic groups are more preferably in the form of their salts with an alkali metal ion or an ammonium ion as counterion.

Hydroxy carboxylic acids are preferable among these compounds referred to, dihydroxyalkylcarboxylic acids are more preferable, while very particular preference is given to α,α-bis(hydroxymethyl)carboxylic acids, especially dimethylolbutyric acid and dimethylolpropionic acid and specifically dimethylolpropionic acid.

In an alternative embodiment, the polyurethanes may comprise not only nonionic hydrophilic but also ionic hydrophilic groups, preferably at one and the same time nonionic hydrophilic and anionic hydrophilic groups.

It is common general knowledge in the field of polyurethane chemistry how the molecular weight of polyurethanes can be controlled through choosing the proportions of the mutually reactive monomers and also through the arithmetic mean for the number of reactive functional groups per molecule.

Components (a), (b), (c) and (d) and also their respective molar quantities are normally chosen such that the ratio A:B where
A) is the molar quantity of isocyanate groups, and
B) is the sum total formed from the molar quantity of hydroxyl groups and the molar quantity of functional groups capable of reacting with isocyanates in an addition reaction,
   is in the range from 0.5:1 to 2:1, preferably in the range from 0.8:1 to 1.5 and more preferably in the range from 0.9:1 to 1.2:1. It is very particularly preferable for the ratio A:B to be very close to 1:1.

Compounds (a), (b), (c) and (d) aside, monomers having but one reactive group are generally used in amounts up to 15 mol %, preferably up to 8 mol %, based on the total amount of components (a), (b), (c) and (d).

The polyaddition reaction of components (a) to (d) is generally carried out at reaction temperatures of 20 to 180° C., preferably 50 to 150° C. under atmospheric pressure.

The reaction times required may range from a few minutes to some hours. It is known in the field of polyurethane chemistry how the reaction time is influenced by a multiplicity of parameters such as temperature, monomer concentration, monomer reactivity.

The reaction of the diisocyanates may be catalyzed using customary catalysts. Any catalysts customarily used in polyurethane chemistry is suitable for this in principle.

These include, for example, organic amines, especially tertiary aliphatic, cycloaliphatic or aromatic amines, and/or Lewis acid organometallic compounds. Useful Lewis acid organometallic compounds include, for example, tin compounds, for example tin(II) salts of organic carboxylic acids, e.g., tin(II) acetate, tin(II) octoate, tin(II) ethylhexoate and tin(II) laurate and the dialkyltin(IV) salts of organic carboxylic acids, e.g., dimethyltin diacetate, dibutyltin diacetate, dibutyltin dibutyrate, dibutyltin bis(2-ethylhexanoate), dibutyltin dilaurate, dibutyltin maleate, dioctyltin dilaurate and dioctyltin diacetate. Metal complexes such as acetylacetonates of iron, of titanium, of aluminum, of zirconium, of manganese, of nickel and of cobalt are also possible. Further metal catalysts are described by Blank et al. in Progress in Organic Coatings, 1999, vol. 35, pages 19-29.

Preferred Lewis acid organometallic compounds are dimethyltin diacetate, dibutyltin dibutyrate, dibutyltin bis(2-ethylhexanoate), dibutyltin dilaurate, dioctyltin dilaurate, zirconium acetylacetonate and zirconium 2,2,6,6-tetramethyl-3,5-heptanedionate.

Bismuth and cobalt catalysts and also cesium salts may also be used as catalysts. Useful cesium salts include cesium compounds featuring the following anions: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻ and also (Cₙ₊₁H₂ₙ₋₂O₄)²⁻, where n is from 1 to 20.

Here preference is given to cesium carboxylates where the anion conforms to the formulae (CₙH₂ₙ₋₁O₂)⁻ and also (Cₙ₊₁H₂ₙ₋₂O₄)²⁻ where n is from 1 to 20. Particularly preferred cesium salts have monocarboxylate anions of the general formula (CₙH₂ₙ₋₁O₂)⁻, where n is from 1 to 20. Formate, acetate, propionate, hexanoate and 2-ethylhexanoate must here be mentioned in particular.

A suitable apparatus for carrying out the polymerization is a stirred tank, especially when solvents are used to ensure a low viscosity and efficient removal of heat. When the reaction is carried out without a solvent, the usually high viscosities and the usually but short reaction times mean that particularly extruders are suitable, especially self-cleaning multiscrew extruders.

Proceeding in the so-called “prepolymer mixing process”, the initial step is to prepare a prepolymer that bears isocyanate groups. Here components (a) to (d) are chosen such that the A:B ratio defined is above 1.0 to 3, preferably in the range from 1.05 to 1.5. The prepolymer is first dispersed in water and simultaneously and/or subsequently crosslinked or chain extended by the isocyanate groups reacting with respectively amines bearing more than 2 isocyanate-reactive amino groups and amines bearing 2 isocyanate-reactive amino groups. Chain extension even takes place when no amine is added. In this case, isocyanate groups are hydrolyzed to form amino groups which react with still remaining isocyanate groups on the prepolymers by chain extension.

The average particle size (z-average), measured via dynamic light scattering using the Malvern® Autosizer 2 C, of the dispersions prepared in accordance with the present invention is not an essential integer of the present invention, and is in general <1000 nm, preferably <500 nm, more preferably <200 nm and most preferably between 20 and below 200 nm.

Polyurethane dispersions PUD generally have a solids content of 10 to 75 and preferably of 20 to 65 wt % and a viscosity of 10 to 500 m Pas (measured at a temperature of 20° C. and a shear rate of 250 s⁻¹).

There are some applications where it may be sensible for the polyurethane dispersions PUD to be adjusted to a different, preferably lower, solids content, for example by dilution.

Polyurethane dispersions PUD may further be mixed with other typical components for the adduced applications, examples being surfactants, detergents, dyes, pigments, color transfer inhibitors and optical brighteners.

The dispersions may, if desired, be physically deodorized after their preparation.

Physical deodorization may consist in stripping the dispersion using steam, an oxygen-containing gas, preferably air, nitrogen or supercritical carbon dioxide, for example in a stirred vessel as described in DE-B 12 48 943 or in a countercurrent column as described in DE-A 196 21 027.

Solvent S of the present invention is generally used in such an amount in the preparation of the polyurethane that its proportion of the final aqueous polyurethane dispersion, i.e., after step II and any step III, does not exceed 30 wt %, preferably not more than 25, more preferably not more than 20 and most preferably not more than 15 wt %.

The proportion of solvent S in the final aqueous polymer dispersion, especially polyurethane dispersion is generally not less than 0.01 wt %, preferably not less than 0.1, more preferably not less than 0.2, yet more preferably not less than 0.5 and most preferably not less than 1 wt %.

Polyurethane dispersions PUD, especially aqueous polyurethane dispersions PUD, are very useful for coating, impregnating and adhesive bonding of substrates. Suitable substrates are wood, wood veneer, paper, paperboard, card, textile, leather, leather substitute, batting, plastics surfaces, glass, ceramic, mineral-type building materials, apparel, vehicular interior trim, vehicles, metals or coated metals. They find application, for example, in the manufacture of films or foils, for impregnation of textiles or leather, as dispersants, as pigment grind agents, as primers, as adhesion promoters, as hydrophobicizers, as laundry detergent additive or as an additive in cosmetic compositions or in the manufacture of hydrogels or shaped articles.

Used as coating materials, polyurethane dispersions PUD are especially useful as primers, surfacers, pigmented topcoats, and clearcoats in the area of large-vehicle finishing or automotive refinishing. The coating materials are particularly useful for applications demanding a particularly high level of application consistency, outdoor weathering resistance, appearance, fastness to solvents, chemicals and water, as in large-vehicle finishing and automotive refinishing.

The polyurethane dispersions PUD of the present invention are very environmentally friendly by virtue of utilizing renewable raw material and display properties that are at least equivalent to those based on petrochemical raw materials.

In addition, polyurethane dispersions PUD and/or polyurethane dispersions obtained by the process of the present invention have at least one of the following advantages over prior art polymer or polyurethane dispersions:
an improved life-cycle assessment through using renewable raw materials.

The present invention further provides polyurethane dispersions obtained by a process of the present invention.

The present invention further provides coating compositions comprising at least one polyurethane dispersion of the present invention, and also entities coated therewith.

The invention further provides the method of using polyurethane dispersions of the present invention for coating, impregnation or adhesive bonding of surfaces such as leather, wood, textile, leather substitute, metals, plastics, apparel, furniture, automotive interior trim, vehicles, paper, organic polymers, especially polyurethane.

The invention further provides coating compositions comprising aqueous polyurethane dispersions and coating compositions produced from polyurethane dispersions of the present invention.

### EXAMPLES

Polyesterol 1 is formed from sebacic acid (from renewable raw materials), adipic acid (molar ratio 1/1) and 1,3-propanediol (from renewable raw materials), molar mass 1400 g/mol.

Polyesterol 2 is formed from adipic acid, neopentyl glycol and 1,6-hexanediol (molar ratio 1/1), molar mass 1400 g/mol.

### Example 1

A stirred tank fitted with a thermometer and a reflux condenser was initially charged with 420 g (0.30 mol) of polyesterol 1, 27.0 g of 1,4-butanediol, 100 g of acetone and 0.30 ml of dibutyltin dilaurate followed by heating to 65° C. This was followed by the admixture of 89.8 g (0.404 mol) of isophorone diisocyanate and 106.7 g of 4,4′-dicyclohexylmethane diisocyanate and stirring at 95° C. This was followed by dilution with 850 g of acetone after 210 min.

The NCO content of the solution was determined as 1.16% (computed: 1.04%).

The solution was cooled to 50° C. and admixed with 42.0 g (0.10 mol) of a 40% aqueous solution of the Michael adduct of ethylenediamine onto sodium acrylate. This was followed by dispersal by admixture of 1200 g of water. Immediately following dispersal, a mixture of 50 g of water, 2.7 g (0.016 mol) of isophoronediamine and 5.8 g (0.056 mol) of diethylenetriamine was admixed.

After distillation of the acetone, a finely divided polyurethane dispersion having a solids content of 37.2% was obtained.

### Example 2 (Comparative)

A stirred tank fitted with a thermometer and a reflux condenser was initially charged with 420 g (0.30 mol) of polyesterol 2, 27.0 g of 1,4-butanediol, 100 g of acetone and 0.30 ml of dibutyltin dilaurate followed by heating to 65° C. This was followed by the admixture of 89.8 g (0.404 mol) of isophorone diisocyanate and 106.7 g of 4,4′-dicyclohexylmethane diisocyanate and stirring at 95° C. This was followed by dilution with 850 g of acetone after 210 min.

The NCO content of the solution was determined as 1.16% (computed: 1.04%).

The solution was cooled to 50° C. and admixed with 42.0 g (0.10 mol) of a 40% aqueous solution of the Michael adduct of ethylenediamine onto sodium acrylate. This was followed by dispersal by admixture of 1200 g of water. Immediately following dispersal, a mixture of 50 g of water, 2.7 g (0.016 mol) of isophoronediamine and 5.8 g (0.056 mol) of diethylenetriamine was admixed.

After distillation of the acetone, a finely divided polyurethane dispersion having a solids content of 38.4% was obtained.

Floats were prepared from

120 g of Lepton Schwarz NB,

150 g of Lepton Filler FCG,

400 g of polyurethane dispersion, and

100 g of Corial Ultrasoft NT

and thickened with Lepton Paste VL to an efflux viscosity of 35 sec in the 4 mm Ford cup. These floats were reverse roll coated at 8.0 g/ft² onto a full-grain leather.

Lepton® Schwarz NB is a pigment formulation from BASF SE for application in aqueous finishes which is based on carbon black.

Lepton Filler FCG is an aqueous dispersion of inorganic delusterants with casein, fat and waxes from BASF SE for use in aqueous finishes.

Corial® Ultrasoft NT is an aqueous acrylate polymer dispersion from BASF SE for use in aqueous finishes.

Lepton® Paste VL is a PU dispersion in admixture with water and comparatively highly hydric alcohols from BASF SE for use in aqueous finishes.

### Table 1 Summarizes the Test Results:

| | Example 3 (poly- | Example 4 (poly- |
|---|---|---|
| | urethane dispersion | urethane dispersion |
| | from Example 1) | from Example 2) |
| DIN EN ISO 11644 | 7.4 | 8.1 |
| adherence of finish (N/cm) | | |
| DIN EN ISO 5402 flex life | no damage | no damage |
| dry 100 000 x | | |
| DIN EN ISO 5402 flex life | no damage | no damage |
| dry at −10° C. 30 000 x | | |

Polyurethane dispersions of the present invention, which are based on renewable raw materials, have the same performance characteristics as polyurethane dispersions formed from petrochemical raw materials.

1. A polyurethane dispersion PUD comprising at least one polyurethane P based on at least one polyisocyanate and at least one polyester polyol PES, wherein the polyester polyol PES is based on at least one polyhydric alcohol A and at least one dicarboxylic acid D, wherein at least one polyhydric alcohol A and/or at least one dicarboxylic acid D were at least partly derived from renewable raw materials.

2. The polyurethane dispersion according to claim 1 wherein the at least one dicarboxylic acid D is sebacic acid, azelaic acid, succinic acid, furan dicarboxylic acid or tetrahydrofuran dicarboxylic acid.

3. The polyurethane dispersion according to claim 1 wherein the at least one dicarboxylic acid D comprises sebacic acid at least partly derived from renewable raw materials, and adipic acid.

4. The polyurethane dispersion according to claim 1 wherein the at least one polyhydric alcohol A was at least partly derived from renewable raw materials.

5. The polyurethane dispersion according to claim 1, wherein the at least one polyhydric alcohol A is selected from the group consisting of aliphatic C2-C6 diols.

6. The polyurethane dispersion according to claim 1 wherein the at least one polyhydric is selected from the group consisting of 1,3-propanediol and 1,4-butanediol.

7. The polyurethane dispersion according to claim 1, wherein the polyurethane comprises at least one chain extender.

8. The polyurethane dispersion according to claim 1, wherein the polyurethane dispersion is aqueous.

9. A process for producing a polyurethane dispersion, which process comprises the step of reacting at least one polyisocyanate and at least one polyester polyol PES, wherein the polyester polyol PES is based on at least one polyhydric alcohol A and at least one dicarboxylic acid D, wherein at least one polyhydric alcohol A and/or at least one dicarboxylic acid D were at least partly derived from renewable raw materials.

10. The process according to claim 9 comprising the steps of:
I. preparing a polyurethane by reaction of
a) at least one polyfunctional isocyanate having 4 to 30 carbon atoms,
b) diols whereof
b1) 10 to 100 mol %, based on the total amount of diols (b), have a molecular weight of 500 to 5000, and
b2) 0 to 90 mol %, based on the total amount of diols (b), have a molecular weight of 60 to 500 g/mol,
c) optionally further polyfunctional compounds other than the diols (b) and having reactive groups in the form of alcoholic hydroxyl groups or primary or secondary amino groups, and
d) monomers having at least an isocyanate group or at least an isocyanate-reactive group which are other than the monomers (a), (b) and (c) and which further bear at least a hydrophilic group or a potentially hydrophilic group, whereby polyurethanes are rendered dispersible in water,
to form a polyurethane in the presence of a solvent S, and
II. then dispersing the polyurethane in water,
III. wherein polyamines may optionally be added after or during step II,
wherein diol b1) comprises at least one polyester polyol PES based on at least one polyhydric alcohol A and at least one dicarboxylic acid D, wherein at least one polyhydric alcohol A and/or at least one dicarboxylic acid D were at least partly derived from renewable raw materials.

11. A polyurethane dispersion obtained by the process according to claim 9.

12. A method comprising coating, impregnation or adhesive bonding of wood, wood veneer, paper, paperboard, card, textile, leather, leather substitute, batting, plastics surfaces, glass, ceramic, mineral-type building materials, apparel, vehicular interior trim, vehicles, metals or coated metals, with the polyurethane dispersion of claim 1.

13. A coating composition comprising the aqueous polyurethane dispersion PUD according to claim 1.
